(19) United States
(12) Patent Application Publication
(10) Pub. No.: US 2012/0246148 A1
(43) Pub. Date: Sep. 27, 2012

(54) Contextual Display and Scrolling of Search Results in Graphical Environment

(75) Inventor: Tomer Dror, Karmiel (IL)

(73) Assignee: INTERGRAPH TECHNOLOGIES COMPANY, Las Vegas, NV (US)

(21) Appl. No.: 13/053,586

(22) Filed: Mar. 22, 2011

(51) Int. Cl. G06F 17/30

(52) U.S. Cl. 707/722; 707/E17.014

(57) ABSTRACT

A system and method are presented for aggregating and displaying information that relates to items in an engineering design. A system for designing engineering projects filters components of interest to a user, then collects data pertaining to the components from a set of databases that may be associated with mutually incompatible applications. The system presents, in a simple manner, an integrated display of the component properties and visual representations of the filtered components, both in isolation and in context. Multiple filtered components may be scrolled using a scrolling device such as a mouse wheel. The visual representations may be cropped with a resizable crop box, and non-selected components outside the crop box may have varying levels of opacity.

### TECHNICAL FIELD

The present invention relates to computerized tools that assist with the design of engineering projects, and more particularly to graphical displays of individual components of engineering projects, wherein the graphical or numerical properties of the components are shown to a user in the context of the overall design.

### BACKGROUND ART

Many interactive, graphical computer software applications process vast amounts of complex three-dimensional model data for presentation on one or more video displays. Such applications include, for example, computer-assisted design (CAD) tools for designing three-dimensional articles, buildings, and vehicles for manufacture, and geographic information system (GIS) tools, which are used to track public transit systems or communications networks.

These applications are often at the heart of design systems that must manipulate a complex array of information. A typical application may have to process a design containing thousands or even millions of components. And every component may be associated with information pertaining to its purpose in the design, its specifications and required tolerances, its cost and lead time, a vendor to manufacture it, a construction schedule, on-site delivery data, testing and check-out data, and many other data. These data are not typically stored in one location; rather, they exist in a collection of databases associated with several different applications that have different users. For example, the 3D specification of a component may be useful to a design engineer, while the cost and lead time information may be useful to a project manager. Because of the diverse nature of the data, assembling them in one place to obtain a global perspective of all information pertaining to a particular component is difficult.

### SUMMARY OF ILLUSTRATIVE EMBODIMENTS

Various embodiments of the invention simultaneously present two views of a component, a local view and a global view, in an integrated display, thereby improving ease of use of the design system. These embodiments improve prior art systems because, among other reasons, they collect the data displayed in the integrated display from multiple database sources that were created by mutually non-interoperable software applications. Further, by showing both local and global information together, such embodiments eliminate the distraction of switching between these software applications, or between views in a single application, in order to understand both of these design perspectives.

A first embodiment includes a method of displaying information that relates to a plurality of items in an engineering design. Each item is associated with a visual representation (as defined below) that shows both the item and at least one other item in the design. The basic method has three steps: first receiving a selection of properties that relate to the engineering design; next retrieving records from a set of databases having data records; then causing display, on a graphical display device, of selectable indicia that correspond to at least one of the retrieved records. Each record in each database has information associated with an item in the plurality of items. The retrieved records relate to one or more items that have at least one property in the received selection of properties, as is known from the art of database programming. Selection of an indicium causes simultaneous display of two images. The first image is the visual representation associated with the item of the record that corresponds to the selected indicia. The second image is a cropped image that shows a cropped portion of the visual representation.

There are various enhancements that may be applied to this embodiment. For example, the indicia may be arranged on the display device in a scrollable list, and the selection is performed in response to receiving an input from a user input device (such as a mouse) having a physical input that has a scrolling function (such as a scroll wheel). In some related embodiments, at least two of the databases have different storage formats. The visual representation associated with at least one item in the plurality of items may be an image file or a graphical user interface of a software application. The cropped image may be a portion of the visual representation that is enlarged and centered on the item, and may include a crop area that may be resized by a user to display more or less of the enlarged portion. In some embodiments, a portion of the visual representation that does not include the item has an opacity that is user-adjustable.

A further embodiment includes a tangible, computer-usable storage medium on which is stored program code for performing the steps of the above method or its enhancements. Another further embodiment includes a system for carrying out the steps of the method or its enhancements. Such a system may be a computer configured to execute the program code just described.

### BRIEF DESCRIPTION OF THE DRAWINGS

The foregoing features of embodiments will be more readily understood by reference to the following detailed description, taken with reference to the accompanying drawings, in which:

FIG. 1 shows the various components of a system in accordance with an embodiment of the present invention;

FIG. 2 shows a collection of graphical properties, stored in one or more databases of FIG. 1, that are possessed by a plurality of items in an engineering design;

FIG. 3 shows a collection of functional properties possessed by these items;

FIG. 4 shows a representation of a graphical display for filtering items, from the one or more databases, for contextual display;

FIG. 5 shows graphical properties of items that have been filtered;

FIG. 6 shows a representation of a graphical display for displaying information that relates in general to the filtered items, and in particular to a currently selected item;

FIG. 7 shows the graphical display of FIG. 6, after a user has enlarged the crop area of the currently selected item;

FIG. 8 shows the graphical display of FIG. 7, after a user has altered the opacity of the non-selected items;

FIG. 9 shows the graphical display of FIG. 6, after a user has selected a new item for contextual display; and

FIG. 10 is a flowchart showing a method for displaying items in accordance with one embodiment of the invention.

### DETAILED DESCRIPTION OF ILLUSTRATIVE EMBODIMENTS

As used in this description and the accompanying claims, the following terms shall have the meanings indicated, unless the context otherwise requires:

A visual representation of an item is an image of the item in a specified design context. An item, such as a component in an engineering design, may have several different contexts in relation to the design. For example, in a chemical process plant, a furnace used to heat a reaction vessel may be viewed in the context of a system of fuel and waste pipes, a system of electrical wiring, a system of heat sources, and so on. Each context may have its own visual representation; for example, the furnace may appear in the structural blueprints, the electrical wiring diagram, in a 3D view of a cross-section of the plant, and so on. In this way, the furnace is associated with several visual representations. Conversely, any given visual representation typically will show many different items, each of which is associated with it. For example, the electrical wiring diagram will show many electrical components. Thus, there is a many-to-many relationship between design elements and visual representations.

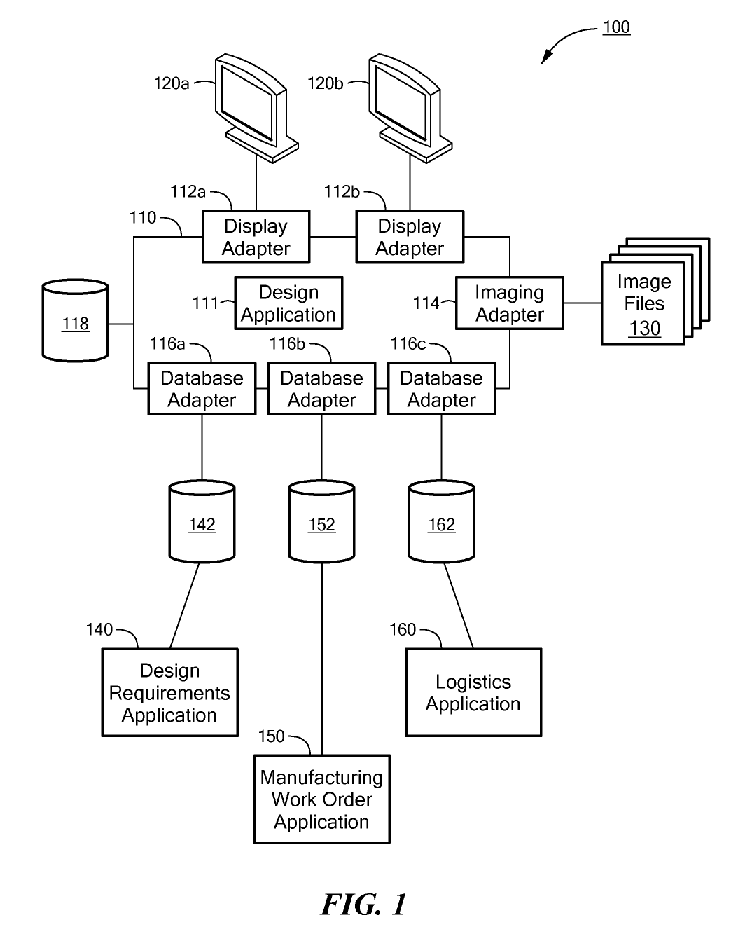

FIG. 1 shows the various components of a computer system 100 that may implement various embodiments of the invention. The heart of computer system 100 is a design system 110 for assisting in the design and management of engineering projects. The design system 110 may be a computer as is known in the art, several computers, or a portion of a single computer, but need only include such hardware, firmware, and software as is necessary to perform the functions of the methods described herein. Thus, it will be understood that in some embodiments of the invention, more or fewer components will be present than those described in connection with the typical embodiment of FIG. 1. For clarity, FIG. 1 omits various components of design system 110, such as a computer processor, volatile memory, input devices like mice and keyboards, and other devices and subsystems known to be useful in the art of computer systems generally.

The design system 110 includes a design application 111, which includes a combination of hardware and software for permitting a user to design an engineering project. Exemplary application 111 contains program code for manipulating various information and data relating to the project, program code for a graphical user interface (GUI) that allows the user to visualize the project or its associated data in 2D or 3D, and program code for a series of control elements in the GUI that permit the user to modify the underlying project data. Other embodiments of application 111 may accomplish these features in hardware or firmware for additional speed.

The design system 110 includes a number of adapters for communicating with other devices and systems. Thus, the design system 110 includes two display adapters 112a, 112b for transmitting images from application 111 to display devices 120a, 120b, although more or fewer display devices may be used. Exemplary display adapters 112a, 112b are graphics cards, but networking cards, or other hardware or software devices as known in the art may be used. Exemplary display devices 120a, 120b are computer monitors, but televisions, smartphones, PDAs, or any other adequate display devices may be used. The types of images transmitted include, for example, 3D schematics of a project, 2D blueprints of the project, other schematics of various mechanical, electrical, safety, or other systems of the project, project schedules, personnel rosters, and images of any other aspect of the design and implementation of the project. The images may represent text documents, spreadsheets, databases, or any other organization of information, including the graphical display of a software application.

The design system 110 also includes an imaging adapter 114 for generating and reading image files 130. The imaging adapter 114 is typically embodied as file formatting software that formats and parses image data, including JPEG, GIF, PNG, and other image formats as known in the art. Images of schematics, blueprints, and so on are processed by the imaging adapter 114 to create image files 130. Conversely, the image files 130 may be read and parsed by imaging adapter 114 for transmission to the display devices 120.

In accordance with various embodiments of the invention, the design system 110 interfaces with several other systems and applications associated with the project. For example, a design requirements software application 140 may be used in the initial phases of design to collect and organize all of the design requirements pertaining to one or more projects. The requirements application 140 stores all of its data in a database 142. When all of the requirements have been determined, parts may need to be ordered, for which a manufacturing work order application 150 is used. Manufacturing application 150 uses a database 152 to store its data. A logistics application 160 may be used to coordinate project implementation according to a work breakdown structure, for example as shown in a Gantt chart. Its data is stored in database 162.

As is known in the art, each database includes a collection of records, and in accordance with various embodiments of the invention, each record in the database has information that is associated with a component in the design. As will be appreciated, the databases 142, 152, 162 may contain data in different formats, such as flat text, CSV, XLS, XML, ISAM, and so on. To facilitate interoperability of the design application 111 with these other systems, the design system 110 includes database adapters 116a-c that permit the design system 110 to read (and optionally write) data to the databases 142, 152, 162 respectively. Additionally, to the extent required, the design system 110 includes its own database 118 of information in which it stores project design data.

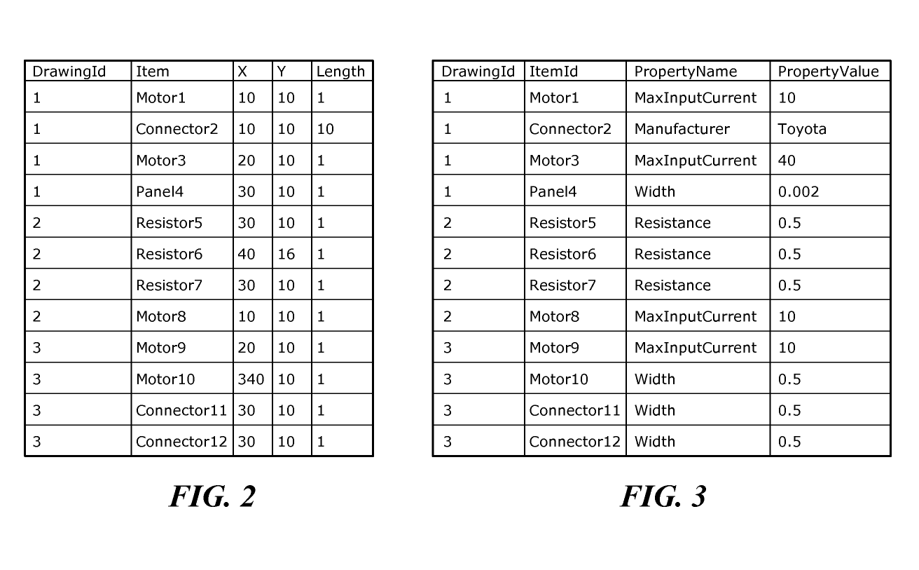

FIG. 2 shows an example collection of graphical properties, stored in one or more of the databases 118, 142, 152, 162. Each item in the design has various graphical properties, and is associated with one or more visual representation. A visual representation for one item may be a drawing, such as an image file 130. Alternatively, a visual representation for a different item may be a dynamically-generated graphical user interface of a software application, such as a web browser, a word processor, a spreadsheet, a slideshow application, a diagramming application, or other application. Such visual representations may be obtained from the external application by the design system 110 using, in one embodiment, Object Linking and Embedding (OLE) technology developed by Microsoft Corporation of Redmond, Wash. A different embodiment instead may use a web service, such as one that conforms to the Web Services Description Language (WSDL), or that uses XML-RPC or its successor, SOAP. Another embodiment may use Microsoft's Windows Communication Foundation (WCF), or other comparable technology for this purpose.

FIG. 2 shows three drawings having drawing IDs 1, 2, and 3. Each drawing includes four components; thus, drawing 1 includes Motor 1, Connector2, Motor3, and Panel4, and so on for the other drawings. The graphical properties for these components are represented as X- and Y-coordinates and a length, as shown. In a typical application, many more properties would be present, including complete descriptions of the sizes and shapes of these components so they may be rendered in the drawing—these additional fields are omitted for clarity.

FIG. 3 shows a sample of functional properties possessed by the items of FIG. 2. Thus, Motor1 has a maximum input current of 10 amperes. In a typical embodiment, many more functional properties would be contained in the database, and the values listed in FIG. 3 are exemplary only. As will be appreciated from the above discussion, the functional properties of various components may be stored in one of the databases 118, 142, 152, 162 while the graphical properties of those same components may be stored in a different database, or several different databases.

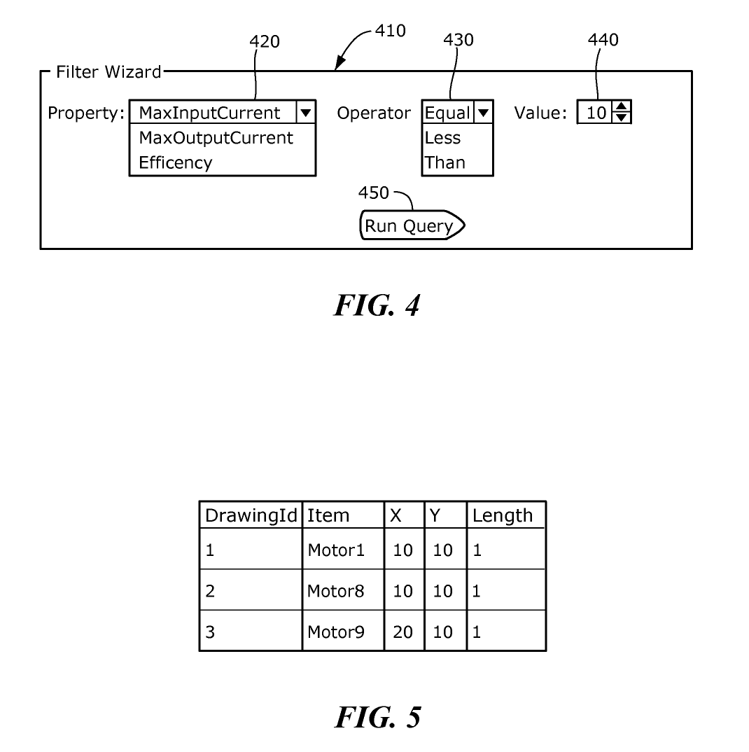

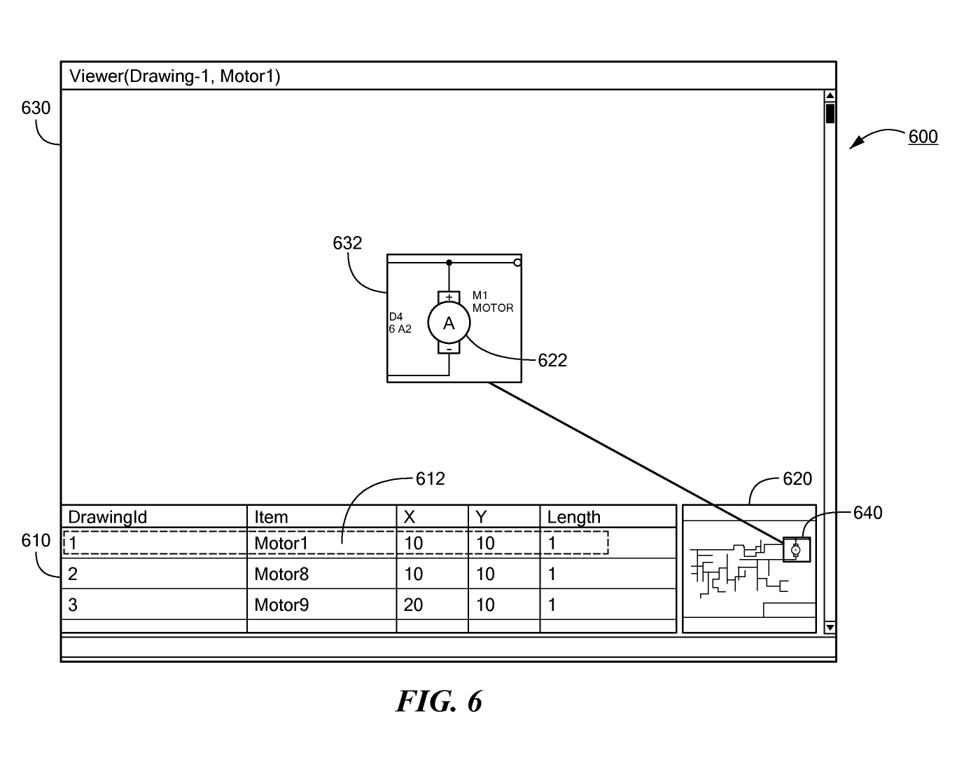

It is useful in various embodiments for the design application 111 to provide a user with the ability to select various items from the design. For example, an engineer may wish to focus her attention on a particular subset of the motors, or on the heat sources. To that end, FIG. 4 is a representation of a graphical display for filtering items, from the one or more databases, for contextual display in accordance with an embodiment of the invention. A filter window 410 is graphically displayed on a display as part of the graphical user interface. The filter window 410 includes a property selector 420, an operator selector 430, a value selector 440, and a Run Query button 450. The property selector 420 includes a selection of properties in a pull-down menu. These properties correspond to the functional properties of FIG. 3. Each functional property has a related value. The operator selector 430 is provided as a pull-down menu to permit a user to select a relationship relative to that value, and a value selector 440 is provided as a spinner to receive a value corresponding to the operator. Thus, as shown in FIG. 4, the currently selected filter is “components having a maximum input current equal to 10 amperes”. Once the user has selected an appropriate filter, the design system receives and processes the selection when the user presses the Run Query button 450. After the filtering process is complete, the components that meet the selection criteria are displayed as discussed in greater detail below in connection with FIG. 6.

It should be understood that the exemplary graphical interface shown in FIG. 4 is not limiting. In particular, the selectors 420, 430, 440 may be other than pull-down menus and spinners. Any input widgets known in the art may be used to receive a filter selection, including for example check boxes, radio buttons, clickable icons, text fields, text areas, list windows, scroll bars, sliders, tables, and trees. Additionally, other input fields may be present in the GUI, such as component name, component type, design system (electrical, structural, sensor system, etc.), project name or subproject name, and the like.

FIG. 5 shows the graphical properties of items that have been filtered using the example filter of FIG. 4 and the listings of FIGS. 2 and 3. In particular, the example filter is “components having a maximum input current equal to 10 amperes”. From FIG. 3, these components are Motor1, Motor8, and Motor9, but not Motor3. Referring then to FIG. 2, for example, Motor1 appears in drawing 1, its coordinates are (10, 10), and its length is 1. Motor8 appears in drawing 2, and has the same coordinates and length. These data are identified for all components that match the filter criteria, and are collected in a single list as shown in FIG. 5. As noted above, the functional and graphical properties of each component may be stored in different databases. Thus, in one embodiment the design system is capable of assembling and manipulating information derived from a number of different databases, which allows it to perform the indicating filtering function using data generated by several different external applications.

FIG. 6 is a representation of an example graphical display for displaying information that relates in general to the filtered items. The graphical user interface (GUI) 600 has several areas, including a scrollable list of filtered components 610, a secondary viewing panel 620 for viewing a visual representation of an item, and a primary viewing panel 630 for viewing a cropped image of the visual representation. Each of these is described in greater detail in turn.

In this example embodiment, the scrollable list 610 includes a collection of selectable indicia that correspond to the database records retrieved by the search process described above. Thus, Motor1, Motor8, and Motor9 appear in the search results, along with their relevant graphical properties. It will be understood that, in addition to their graphical properties, the functional properties of the relevant components may be displayed, along with any other associated information.

In FIG. 6, the first row in its entirety is a selectable indicium 612, and is shown in a highlighted state. In alternative embodiments, other indicia may be used, such as icons, and in their selected state they may be highlighted using an outline as shown, a different colored background, different colored text, a combination of these, or they may not be highlighted at all. When a user selects an indicium, for example the first row of FIG. 6, the design system causes simultaneous display of two images of the component that corresponds to the selected indicium, one image in the primary viewing panel 630 and one in the secondary viewing panel 620.

The secondary viewing panel 620 includes, for the selected component, a visual representation of the component identified by an indicium 612 in its larger context. In FIG. 6, for example, the visual representation is an entire electrical wiring diagram which is stored in a file as Drawing 1. As noted above, a component may be associated with several visual representations. If a particular system or subsystem is not one of the filter criteria, the same physical component may have several indicia in the list 610, one for each context, and each indicium is associated with a different visual representation that may be displayed in the secondary viewing panel 620. The visual representation shown in the panel 620 also includes many other components, including the component identified by the selected indicium.

The primary viewing panel 630 includes a viewing area 632 that has an enlarged view of the visual representation. The view is centered on the selected component 622 using the coordinates of the component. In particular, the view corresponds to crop boundaries, shown by a box 640, within the visual representation shown in the panel 620. The view of the selected component is scaled and rotated to a standard size and orientation for this type of component (in this case, a motor). In some embodiments this is done automatically, while in others, the visual representation shown in the panel 620 is scaled by a fixed magnification. In some embodiments, the user can change magnification using a GUI widget such as a slider bar (not shown). The viewing area 632 is itself centered in the panel 630, and its initial size may be determined using graphical properties of the component. For example, Motor1 has length 1, so the viewing area 632 has a length and width of approximately 2.

By simultaneously presenting a magnified view of the component in the primary viewing panel 630 and a contextual view of the component in the secondary viewing panel 620, the GUI advantageously allows a user to simultaneously see both local and global views of the component in its subsystem context, thereby improving ease of use of the design system. This system improves prior art systems in part because it eliminates the distraction of switching between software applications, or between views in a single application, in order to visualize both local and global properties of a component. It also advantageously collects the data displayed in list 610 and the visual representations of the panels 620, 630 from multiple databases 118, 142, 152, 162, some of which may have been created by mutually non-interoperable software applications.

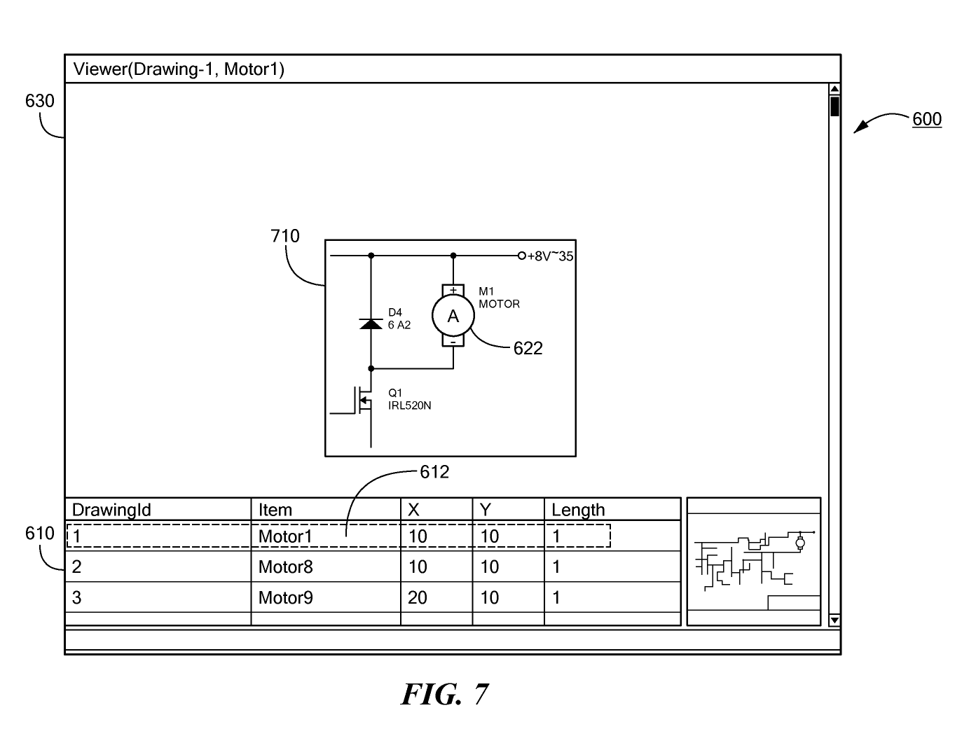

To further improve ease of use, an embodiment of the invention may include other features in a GUI. For example, the embodiment may give a user the ability to enlarge the crop area, to display more or fewer nearby components. Such an embodiment is shown in FIG. 7, in which a viewing area 710 now shows nearby electrical components. For example, it is now clear that the positive terminal of the selected motor is connected to an 8V supply. While the crop area of FIG. 6 was a square, the crop area of FIG. 7 is a larger rectangle of unequal dimensions.

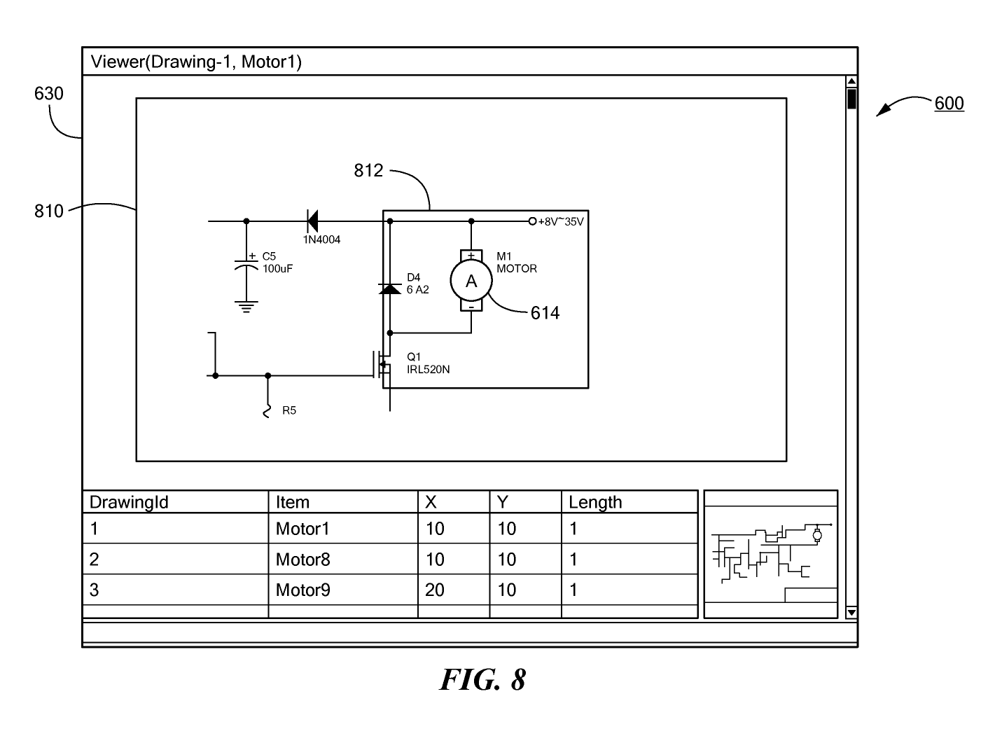

In another embodiment, the user may adjust the opacity of the portions of the visual representation not within the cropped area. Such an embodiment is pictured in FIG. 8, where the user has reduced the opacity from 100%, as in FIG. 6, down to 0%. Thus, in FIG. 8, the user has set all of the viewing area 810 to be fully visible. Opacities between 0% and 100% may be used. A crop box 812 is shown for reference, and indicates to the user which portions of the viewing area 810 will be darkened or lightened by adjusting the opacity because they are outside the crop box 812. While not shown in FIG. 8, in some embodiments a scroll bar or a mouse may be used to navigate the enlarged view when the entire view does not fit into the viewing area 810. For example, a click-and-drag operation as known in the art may be performed to move the displayed portion of the visual representation.

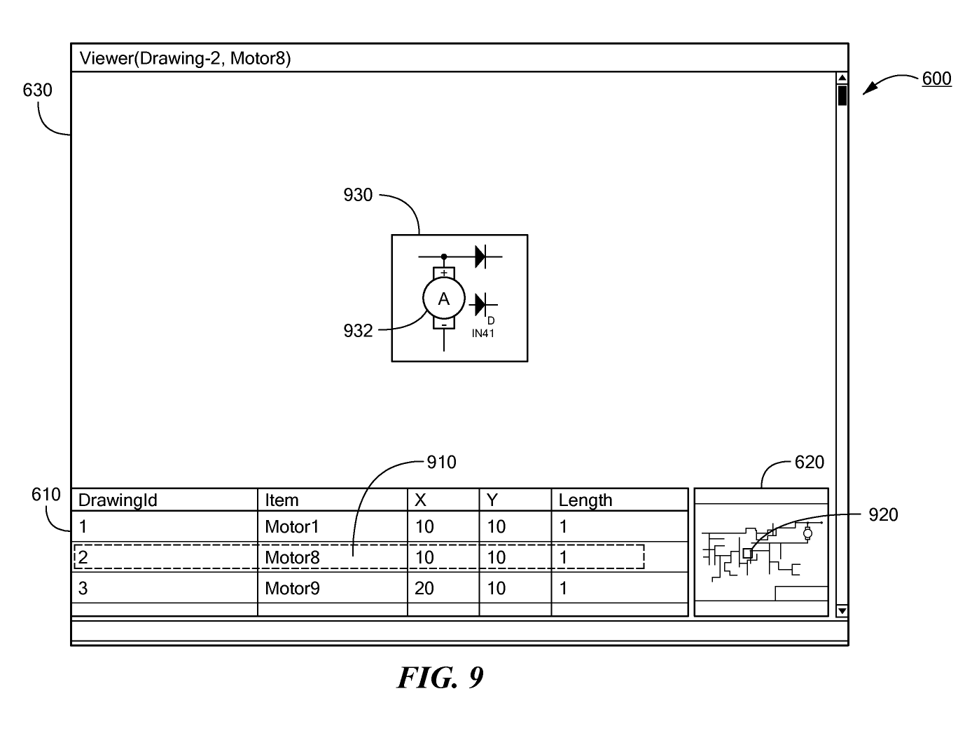

In addition to viewing the visual representation associated with the first selected indicium, the user may select another indicium, as shown in FIG. 9. Here, a second indicium 910 has been selected, corresponding to the component 920 in Drawing 2. This component (namely, Motor8) is shown in a viewing area 930 as an enlarged component 932. The component has been scaled and rotated so that its image may be easily compared with the image of the previous component. In some embodiments, this is done automatically, while in others the user must scale and rotate the view according to other widgets in the GUI (not shown).

Selection of the second indicium may be performed using any number of techniques, including the use of a user input device that has a physical input with a scrolling function. For example, a scroll wheel on a mouse may be used. In another embodiment, an input device with a trackball may be used. In yet another embodiment, a touch pad having specified area (typically a strip along the right-hand edge) is used to scroll between items in the list 610. While scrolling between images is known in the art, various embodiments of the present invention permit scrolling between images of components, filtered using specific search criteria, that are dynamically centered and enlarged based on graphical properties retrieved from one or more databases. The scrollable feature of these embodiments is thus an improvement over the prior art, as all of the visual information and graphical data from multiple sources is collected together, resizing and centering is automated, and several views of each component are displayed in an integrated display that permits simple scrolling.

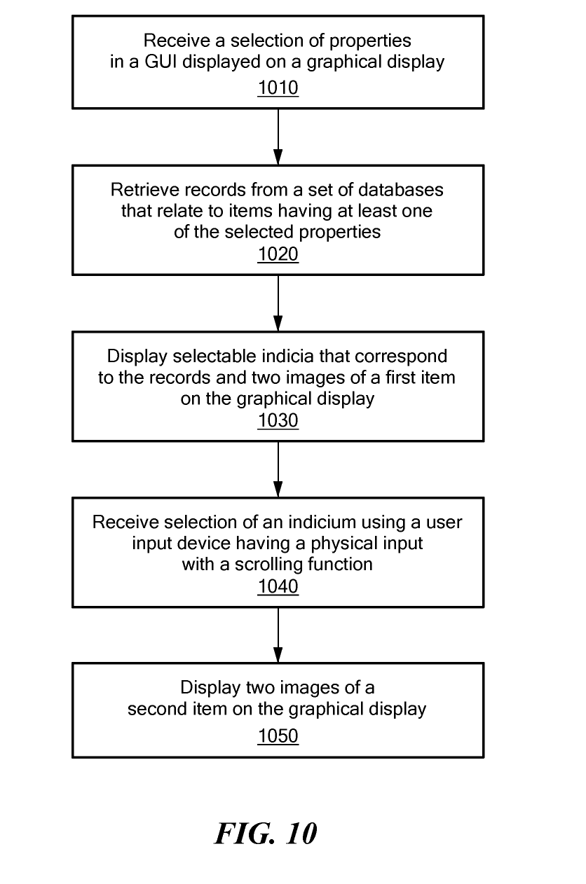

FIG. 10 is a flowchart showing a method for displaying items in accordance with one embodiment of the invention. In step 1010, an embodiment receives a selection of properties in a GUI that is displayed on a graphical display. The properties may be selected using an input window such as that shown in FIG. 4 and described above. In step 1020, the embodiment retrieves records from a set of databases that relate to items having at least one of the selected properties. A typical results list is shown in FIG. 5. In step 1030, the embodiment displays selectable indicia that correspond to the retrieved records, and two images of a first item, on the graphical display. An example of such a display is shown in FIG. 6. The first image is a visual representation of the first item in the list, such as the secondary viewing panel 620. The second image is a cropped, enlarged view of the first item in the list, such as shown in the viewing area 632. In step 1040, the embodiment receives selection of an indicium, using a user input device having a physical input with a scrolling function, such as a mouse or trackball. Finally, in response to receiving the selection of the indicium, the embodiment displays two images of the second, selected item on the graphical display.

The embodiments of the invention described above are intended to be merely exemplary; numerous variations and modifications will be apparent to those skilled in the art. The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

All such variations and modifications are intended to be within the scope of the present invention as defined in the appended claims

What is claimed is:

1. A method of displaying information that relates to a plurality of items in an engineering design, each item in the plurality of items being associated with a visual representation that shows both the item and at least one other item in the plurality of items, the method comprising:
receiving a selection of properties that relate to the engineering design;
retrieving records from a set of databases having data records, each record in each database having information associated with an item in the plurality of items, the retrieved records relating to one or more items that have at least one property in the received selection of properties; and
causing display, on a graphical display device, of selectable indicia that correspond to at least one of the retrieved records, wherein selection of an indicium causes to be simultaneously displayed:
(i) the visual representation associated with the item of the record that corresponds to the selected indicia, and
(ii) a cropped image that shows a cropped portion of the visual representation associated with said item.

2. The method of claim 1, wherein the indicia relating to the retrieved records are arranged on the display device in a scrollable list, and wherein receiving the selection is performed in response to receiving an input from a user input device having a physical input that has a scrolling function.

3. The method of claim 2, wherein the user input device is a mouse and the physical input is a scroll wheel.

4. The method of claim 1, wherein at least two databases in the set of databases have different storage formats.

5. The method of claim 1, wherein the visual representation associated with at least one item in the plurality of items includes an image file or a graphical user interface of a software application.

6. The method of claim 1, wherein the cropped image comprises a portion of the visual representation that is enlarged and centered on the item.

7. The method of claim 6, wherein the cropped image includes a crop area that may be resized by a user to display more or less of the enlarged portion.

8. The method of claim 1, wherein a portion of the visual representation that does not include the item has an opacity that is user-adjustable.

9. A tangible, computer-usable storage medium on which is stored program code for displaying information that relates to a plurality of items in an engineering design, each item in the plurality of items being associated with a visual representation that shows both the item and at least one other item in the plurality of items, the program code comprising:
program code for receiving a selection of properties that relate to the engineering design;
program code for retrieving records from a set of databases having data records, each record in each database having information associated with an item in the plurality of items, the retrieved records relating to one or more items that have at least one property in the received selection of properties; and
program code for causing display, on a graphical display device, of selectable indicia that correspond to at least one of the retrieved records, wherein selection of an indicium causes to be simultaneously displayed:
(i) the visual representation associated with the item of the record that corresponds to the selected indicia, and
(ii) a cropped image that shows a cropped portion of the visual representation associated with said item.

10. The storage medium of claim 9, further comprising program code for arranging the indicia relating to the retrieved records on the display device in a scrollable list, and program code for determining the selection in response to receiving an input from a user input device having a physical input that has a scrolling function.

11. The storage medium of claim 10, wherein the user input device is a mouse and the physical input is a scroll wheel.

12. The storage medium of claim 9, wherein at least two databases in the set of databases have different storage formats.

13. The storage medium of claim 9, wherein the visual representation associated with at least one item in the plurality of items includes an image file or a graphical user interface of a software application.

14. The storage medium of claim 9, wherein the cropped image comprises a portion of the visual representation that is enlarged and centered on the item.

15. The storage medium of claim 14, wherein the cropped image includes a crop area, further comprising program code for resizing the crop area to display more or less of the enlarged portion in response to a user input.

16. The storage medium of claim 9, further comprising program code for adjusting the opacity of a portion of the visual representation that does not include the item.

17. A system for displaying information that relates to a plurality of items in an engineering design, the system comprising:
a graphical display device;
a set of databases having data records, each record in each database having information associated with an item in the plurality of items; and
a design system coupled to the graphical display device, the visual representations, and the set of databases, the design system comprising:
a display adapter configured to transmit images to the graphical display device;
an imaging adapter configured to generate, and read image files containing, visual representations of the items in the engineering design;
for each database in the set of databases, a database adapter configured to read data from the database; and
a design application configured to (i) receive a selection of properties that relate to the engineering design; (ii) retrieving records from the set of databases, the retrieved records relating to one or more items that have at least one property in the received selection of properties; and (iii) cause display, on the graphical display device, of selectable indicia that correspond to at least one of the retrieved records, wherein selection of an indicium causes to be simultaneously displayed the visual representation associated with the item of the record that corresponds to the selected indicia, and a cropped image that shows a cropped portion of the visual representation associated with said item.

18. The system of claim 17, wherein the display device is configurable to arrange the indicia relating to the retrieved records in a scrollable list, and further comprises a user input device having a physical input that has a scrolling function.

19. The system of claim 18, wherein the user input device is a mouse and the physical input is a scroll wheel.

20. The method of claim 17, wherein at least two databases in the set of databases have different storage formats.

21. The method of claim 17, wherein the visual representation associated with at least one item in the plurality of items includes an image file or a graphical user interface of a software application.
